(19) United States
(12) Patent Application Publication
(10) Pub. No.: US 2023/0326107 A1
(43) Pub. Date: Oct. 12, 2023

(54) MULTIPURPOSE ARTIFICIAL INTELLIGENCE MACHINE LEARNING ENGINE

(71) Applicant: Know Labs, Inc., Seattle, WA (US)

(72) Inventor: Phillip BOSUA, Seattle, WA (US)

(21) Appl. No.: 18/296,558

(22) Filed: Apr. 6, 2023

Related U.S. Application Data
(60) Provisional application No. 63/328,436, filed on Apr. 7, 2022.

(51) Int. Cl. G06T 11/60; G06T 11/00; G06T 11/20; G06T 11/40

(52) U.S. Cl. CPC G06T 11/60; G06T 11/001; G06T 11/203; G06T 11/40

(57) ABSTRACT

A multipurpose artificial intelligence machine learning engine (AIMLE) includes one or more machine learning models which have been trained to perform specific tasks. In one embodiment, the AIMLE includes two or more machine learning models which have been trained using different sets of data to perform different tasks.

### FIELD

This technical disclosure relates to the creation and use of trained machine learning models to assist in creating creative works, to create stock images, to create digital art, to create business logos, and the like.

### SUMMARY

A multipurpose artificial intelligence machine learning engine (AIMLE) includes one or more machine learning models which have been trained to perform specific tasks. In one embodiment, the AIMLE includes two or more machine learning models which have been trained using different sets of data to perform different tasks.

For example, the AIMLE can include a first trained machine learning model that has been trained with a first set of data, and a second trained machine learning model that has been trained with a second set of data. A first external interface is associated with the first trained machine learning model by which a first user can interact with the first trained machine learning model, and a second trained external interface is associated with the second trained machine learning model by which a second user can interact with the second trained machine learning model.

The first trained machine learning model and the second trained machine learning model can be generated by training the same machine learning algorithm with the first and second sets of data, or the first trained machine learning model and the second trained machine learning model can be generated by training different machine learning algorithms with the first and second sets of data.

The first and second sets of data can be any types of data that one wishes to use to generate the first and second trained machine learning models. The first set of data and the second set of data used to train the machine learning algorithms can comprise images and text associated with the images, images, text, sounds, and other types of training data that can be used to train machine learning algorithms.

In one embodiment, the machine learning models described herein can be trained to assist a user in creating a new creative work; or create stock images; or create digital art; or create business logos. In the case of assisting in creating a new creative work, the trained machine learning model can be referred to as a creative work assistant machine learning model which can assist in writing, editing, rewriting, and revising a creative work that a user wishes to create, and otherwise advise the user to help create the creative work. In the case of creating stock images, the trained machine learning model can be referred to as a stock image machine learning model which can create stock images based on an input stock image theme. In the case of creating digital art, the trained machine learning model can be referred to as a digital art machine learning model which can be used to create digital art, for example based on input data such as, but not limited to, variable health data. In the case of creating business logos, the trained machine learning model can be referred to as a business logo machine learning model which can create one or more business logos based on an input request from a user.

In one embodiment described herein, a multipurpose artificial intelligence machine learning engine can include a first trained machine learning model that has been trained with a first set of data; a first external interface associated with the first trained machine learning model by which a first user can interact with the first trained machine learning model; a second trained machine learning model that has been trained with a second set of data; and a second external interface associated with the second trained machine learning model by which a second user can interact with the second trained machine learning model.

In another embodiment described herein, a method can include generating a first trained machine learning model that is trained with a first set of data; generating a second trained machine learning model that is trained with a second set of data; allowing a first user to access and interact with the first trained machine learning model via a first external interface associated with the first trained machine learning model; and allowing a second user to access and interact with the second trained machine learning model via a second external interface associated with the second trained machine learning model.

In another embodiment described herein, a method can include training a machine learning algorithm using a plurality of existing creative works to create a creative work assistant machine learning model, where the existing creative works are in one genre. A plurality of inputs are received from a user into the creative work assistant machine learning model concerning a new creative work that is being created by the user, where the new creative work is in the one genre. For each one of the inputs, the creative work assistant machine learning model generates feedback concerning the new creative work, and the feedback is output to the user.

In another embodiment described herein, a method can include training a machine learning algorithm using a plurality of existing creative works to create a creative work assistant machine learning model, where the existing creative works are in one genre. An input into the creative work assistant machine learning model is then received from a user concerning a new creative work that is being created by the user, where the new creative work is in the one genre. The creative work assistant machine learning model generates feedback concerning the new creative work based on the received input, and the feedback is output to the user. Additional inputs can be received and outputs generated and output to the user.

In another embodiment described herein, a creative work creation system can include an artificial intelligence machine learning engine that includes a creative work assistant machine learning model that is trained on a plurality of exiting creative works, where the existing creative works are in one genre. An external interface is in communication with the creative work assistant machine learning model, with the external interface being configured to receive inputs from a user concerning a new creative work in the one genre that is being created by the user. The creative work assistant machine learning model is configured to generate feedback concerning the new creative work for the received inputs and to output the feedback to the user via the external interface.

In another embodiment, an artificial intelligence machine learning engine can include a plurality of machine learning sub-models. For example, the artificial intelligence machine learning engine can include a first trained machine learning sub-model that is trained with data belonging to a first sub-genre of a data genre and a second trained machine learning sub-model that is trained with data belonging to a second sub-genre of the data genre. A distributor is in communication with the first trained machine learning sub-model and the second trained machine learning sub-model. The distributor is configured to receive an external input, analyze the external input, and distribute the external input to the first trained machine learning sub-model or to the second trained machine learning sub-model.

In still another embodiment, a method of generating digital art can include collecting variable health data non-invasively obtained from one or more mammals, and then inputting the variable health data into a digital art machine learning model that has been trained to generate digital art. New digital art is then generated using the digital art machine learning model based on the variable health data that has been input into the digital art machine learning model.

In still another embodiment, a method can include training a machine learning algorithm using a plurality of images and captions associated with the images to create a stock image machine learning model. A selected stock image theme is then input into the stock image machine learning model, and a plurality of stock images are created using the stock image machine learning model based on the selected stock image theme.

### DRAWINGS

FIG. 1 schematically depicts one example of a system that includes a multipurpose artificial intelligence machine learning engine described herein.

FIG. 2 schematically depicts one example of how the different machine learning models described herein can be generated.

FIG. 3 schematically depicts another example of how the different machine learning models described herein can be generated.

FIG. 4 schematically depicts a creative work creation system described herein.

FIG. 5 schematically depicts a creative work creation method described herein.

FIG. 6 schematically depicts a system for generating stock images described herein.

FIG. 7 schematically depicts one method of generating stock images as described herein.

FIG. 8 schematically depicts another method of generating stock images as described herein.

FIG. 9 schematically depicts a system for generating digital art described herein.

FIG. 10 schematically depicts a method of generating digital art as described herein.

FIG. 11 schematically depicts a system for generating a business logo described herein.

FIG. 12 schematically depicts one method of generating a business logo as described herein.

FIG. 13 schematically depicts another method of generating a business logo as described herein.

FIG. 14 schematically depicts another example of a system that includes a multipurpose artificial intelligence machine learning engine with machine learning sub-models as described herein.

### DETAILED DESCRIPTION

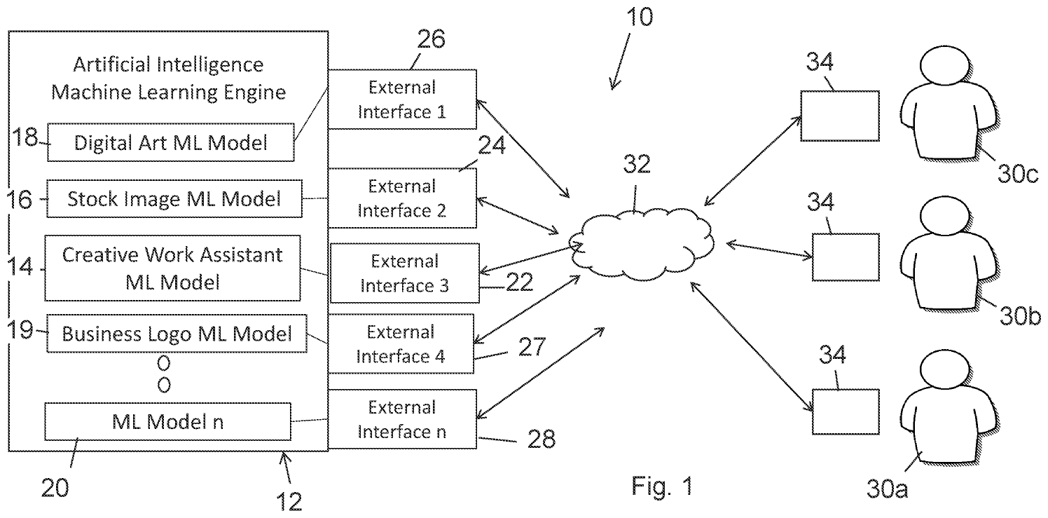

Referring to FIG. 1, a system 10 is depicted that includes a multipurpose artificial intelligence machine learning engine (AIMLE) 12. The AIMLE 12 includes one or more trained machine learning models, for example two or more trained machine learning models, which have been trained to perform different specific tasks. In the case of the AIMLE 12 including multiple trained machine learning models, the trained machine learning models are trained using different sets of data to perform the different tasks.

In the example depicted in FIG. 1, the AIMLE 12 includes a creative work assistant machine learning model (CWAMLM) 14, a stock image machine learning model (SIMLM) 16, a digital art machine learning model (DAMLM) 18, and a business logo machine learning model (BLMLM) 19. The AIMLE 12 can include any two or more of the models 14, 16, 18, 19 in any combination thereof. As described in further detail below, the CWAMLM 14 is trained to interact with a user to assist the user in creating or generating a new creative work. The SIMLM 16 is trained to generate stock images. The DAMLM 18 is trained to generate digital art. The BLMLM 19 is trained to generate one or more business logos based on an input from a user. In addition, the AIMLE 12 can include any number of additional machine learning models 20 that are trained to perform tasks that are different from the tasks performed by the trained models 14, 16, 18, 19.

With continued reference to FIG. 1, each one of the trained models 14, 16, 18, 19, 20 is associated with a corresponding external interface 22, 24, 26, 27, 28 through which a user 30a, 30b, 30c interfaces with the models 14, 16, 18, 19, 20. The users 30a-c can interface with the interfaces 22, 24, 26, 27, 28 directly or indirectly/remotely as shown in FIG. 1, for example via a network 32 such as a local area network, a wide area network such as the Internet, or other network. Communication between the users 30a-c and the external interfaces 22, 24, 26, 27, 28 can be facilitated by electronic user devices 34 such as personal computers with displays and keyboards, laptop computers, tablet computers, mobile phones, and other electronic devices that can display visual outputs, output audible outputs, and receive user inputs.

As described in further detail below, the CWAMLM 14 can assist in writing, editing, rewriting, and revising a creative work that a user wishes to create, and otherwise advise the user to help create the creative work; the SIMLM 16 can create stock images based on an input stock image theme; the DAMLM 18 can be used to create digital art, for example based on input data such as, but not limited to, variable health data; and the BLMLM 19 can generate one or more business logos based on an input request from a user.

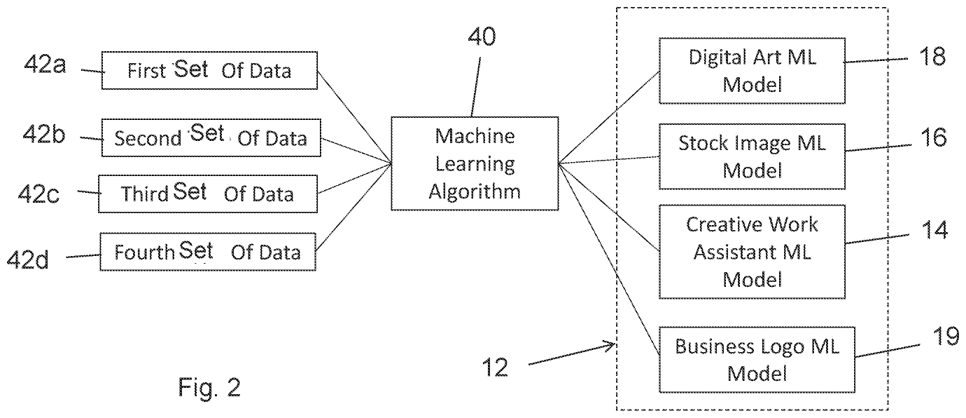

Referring to FIG. 2, one example of how the CWAMLM 14, the SIMLM 16, the DAMLM 18, and the BLMLM 19 can be generated is depicted. In this example, the CWAMLM 14, the SIMLM 16, the DAMLM 18 and the BLMLM 19 can be generated from the same machine learning algorithm 40 that is trained by different sets of data 42a, 42b, 42c, 42d. For example, the CWAMLM 14 may be generated by training the algorithm 40 using a first set of data 42a, the SIMLM 16 may be generated by training the algorithm using a second set of data 42b that is different from the first set 42a, the DAMLM 18 may be generated by training the algorithm using a third set of data 42c that is different from the first set 42a and the second set 42b, and the BLMLM 19 may be generated by training the algorithm using a fourth set of data 42d that is different from the first through third sets 42a-42c of data.

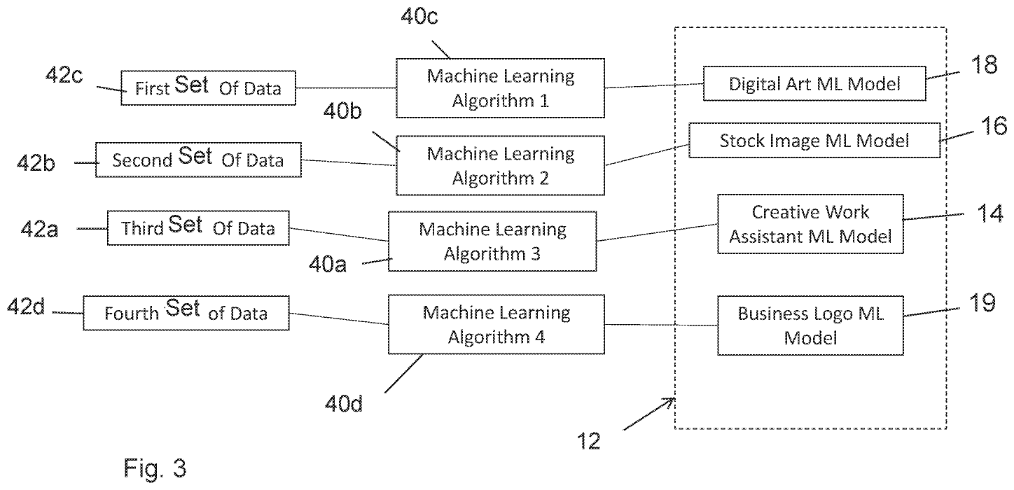

FIG. 3 illustrates another example of how the CWAMLM 14, the SIMLM 16, the DAMLM 18, and the BLMLM 19 can be generated. In this example, the CWAMLM 14, the SIMLM 16, the DAMLM 18, and the BLMLM 19 may be generated from different machine learning algorithms 40a, 40b, 40c, 40d which are respectively trained by the different sets of data 42a, 42b, 42c, 42d. For example, the CWAMLM 14 can be generated by training the algorithm 40a using the first set of data 42a, the SIMLM 16 can be generated by training the algorithm 40b using the second set of data 42b that is different from the first set 42a, the DAMLM 18 can be generated by training the algorithm 40c using the third set of data 42c that is different from the first set 42a and the second set 42b, and the BLMLM 19 can be generated by training the algorithm 40d using the fourth set of data 42d that is different from the first through third sets 42a-42c of data.

The machine learning algorithm(s) 40, 40a-d can be any machine learning algorithm(s) that are suitable for being trained based on the data sets described herein to generate the CWAMLM 14, the SIMLM 16, the DAMLM 18, and the BLMLM 19 and other trained machine learning models described herein. The machine learning algorithm(s) may be supervised learning algorithm(s), unsupervised learning algorithm(s), reinforcement learning algorithm(s), and any combination thereof. For example, the algorithm(s) may be Linear Regression, Logistic Regression, Decision Tree, SVM, Naive Bayes, kNN, K-Means, Random Forest, Dimensionality Reduction Algorithms, or Gradient Boosting algorithms, and combinations thereof. An AI machine learning engine that can be used in the system 10 described herein is the AI machine learning platform created by Know Labs, Inc. of Seattle, Washington. Training machine learning algorithms using training data is well known in the art and examples are described in, for example, U.S. 2022/0015685 and US 2022/0015713, each of which is incorporated herein by reference in its entirety.

The machine learning algorithms can be trained on text using text classification or a text classifier, trained on images using image classification or an image classifier, and trained on audio/sounds using audio/sound classification or an audio/sound classifier. In general, text classification/classifiers, image classification/image classifiers, and audio/sound classification/classifiers are known in the art.

The data sets 42a-42d in FIGS. 2 and 3 can be any types of data sets that one wishes to use to train the algorithm(s) and generate the trained machine learning models, for example the CWAMLM 14, the SIMLM 16, the DAMLM 18 and the BLMLM 19, to perform their desired functions. For example, with respect to the CWAMLM 14, the first set of data 42a can comprise text from multiple books, for example for use in assisting a user in generating a creative work such as literature. With respect to the SIMLM 16, the set of data 42b can comprise a plurality of images and/or text or captions associated with the images for use in generating stock images. With respect to the DAMLM 18, the set of data 42c can comprise text and/or a plurality of images for use in generating digital art. With respect to the BLMLM 19, the set of data 42d can comprise text and/or a plurality of images for use in generating one or business logos.

The AIMLE 12 can comprise the CWAMLM 14, the SIMLM 16, the DAMLM 18, and the BLMLM 19, and optionally the external interfaces 22, 24, 26, 27, 28. The AIMLE 12 can be a single physical storage location whereby the CWAMLM 14, the SIMLM 16, the DAMLM 18, and the BLMLM 19 are stored in a common physical storage location, such as a single server. In another embodiment, the AIMLE 12 can be in multiple storage locations whereby the CWAMLM 14, the SIMLM 16, the DAMLM 18, and the BLMLM 19 are stored in multiple storage locations including separate cloud storage locations.

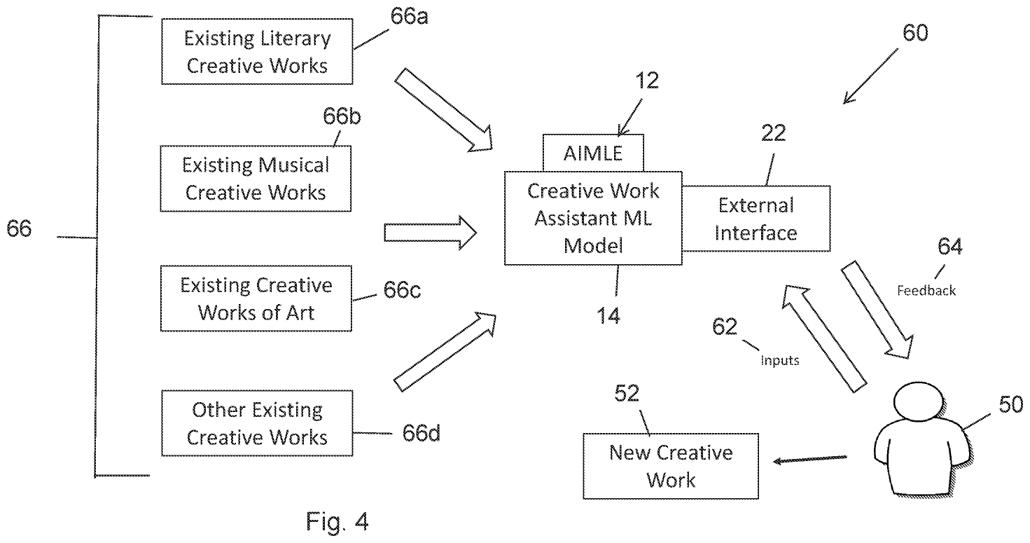

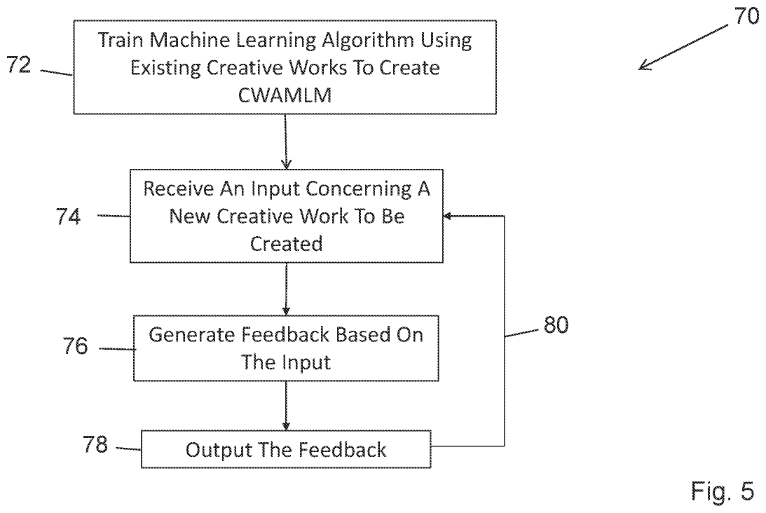

Referring now to FIGS. 4-5, an example of using the CWAMLM 14 to assist a user 50 in creating a new creative work 52 is illustrated. In FIGS. 4-5, features that are the same or similar to features in FIGS. 1-3 are referenced using the same reference numerals. The CWAMLM 14 is trained using a plurality of existing creative works 66 that belong to a common genre. In one embodiment, the training data used to train the CWAMLM 14 can be text from multiple books. The user 50 then interacts with the CWAMLM 14 to assist the user 50 in creating or generating the new creative work 52. The new creative work 52 may be in the same genre or in a different genre as the existing creative works 66. The CWAMLM 14 can assist the user 50 in writing, editing, rewriting, and revising the new creative work 52, and otherwise advise the user 50 to help create the new creative work 52. A creative work is any manifestation or artistic expression of creative effort such as, but not limited to, artwork, literature, music, paintings, software, and others.

The plurality of existing creative works 66 used to train the CWAMLM 14 belong to a common genre. For example, all of the existing creative works 66 can be literary works, or musical works, or works of art, or other types of creative works. Once the CWAMLM 14 is trained, the user 50 who is interested in creating a new creative work in the genre can then interact with the CWAMLM 14 in an iterative process or conversation that includes the user 50 providing an input into the CWAMLM 14 and the CWAMLM 14 providing feedback in response, the user 50 providing another input and receiving another feedback, etc. The inputs can include, but are not limited to, questions, comments, observations, and the like, relating to the new creative work 52. The feedback provided by the CWAMLM 14 to the user 50 in response to the inputs assists the user 50 to create the new creative work 52. The feedback provided by the CWAMLM 14 can include, but is not limited to, comments or observations in response to the input provided by the user 50, suggestions to the user 50 for improving, enhancing or changing the creative work 52, questions to the user, and other feedback suitable for aiding the user in creating the creative work 52.

The interactions between the user 50 and the CWAMLM 14 can be via electronic text characters, for example typed into a keyboard by the user and displayed on a display, and/or audibly via a microphone and a speaker.

Referring to FIG. 4, a system 60 (which may also be referred to as a creative work creation system) is depicted that includes the AIMLE 12, the CWAMLM 14 and the external interface 22 through which the user 50 can interact with the CWAMLM 14 to assist the user 50 in creating the new creative work 52. The AIMLE 12 may or may not include the SIMLM 16, the DAMLM 18 and the BLMLM 19 of FIG. 1, or other trained machine learning model(s) 20. The user 50 can provide inputs 62 to the CWAMLM 14 via the interface 22 and receive feedback 64 from the CWAMLM 14 via the interface 22 responsive to the inputs 62. For example, the inputs 62 may be made via the user device 34 and the feedback 64 may be received via the user device 34 (see FIG. 1).

The existing creative works 66 used to train the CWAMLM 14 can all be from the same genre of creative works. The CWAMLM 14 can be trained using existing creative works 66 from any genre of existing creative works. For example, the existing creative works 66 used to train the CWAMLM 14 can all be existing literary works 66a (i.e. literary works genre), or existing musical works 66b (i.e. musical work genre), or existing works of art 66c (i.e. works of art genre), or other types of existing creative works 66d, and many others. In another embodiment, the existing creative works 66 used to train the CWAMLM 14 can be from different genres of creative works.

Examples of the existing literary works 66a that can be used to train the CWAMLM 14 includes, but are not limited to, literary fiction, literary non-fiction, written speeches, song lyrics, newspaper articles, magazine articles, website articles, social media postings, screenplays, copywriting, marketing materials, screenplays, manuscripts, poetry, dissertations, theses, reports, pamphlets, brochures, textbooks, computer programs, and many others.

Examples of the existing musical works 66b that can be used to train the CWAMLM 14 includes, but are not limited to, sheet music, written song lyrics, audible song lyrics, audible melodies and other music accompanying lyrics, soundtracks, other sound and audio, and many others. Training a machine learning model using sound and audio, for example using a sound classifier, is known in the art.

Examples of the existing works of art 66c that can be used to train the CWAMLM 14 includes, but are not limited to, digital art, traditional works of art (for example, paintings) produced on a substrate, sculptures, photographs, maps, globes, charts, and many others. The existing works of art may be two dimensional or three dimensional. Training a machine learning model using physical works of art, for example using an image classifier, is known in the art.

Examples of the others types of existing creative works 66d that can be used to train the CWAMLM 14 includes, but are not limited to, technical drawings, architectural drawings or plans, blueprints, diagrams, mechanical drawings, photographs of buildings, bridges and other human constructed structures, and many others.

The new creative work 52 that is being created by the user 50 can be in the same genre as the existing creative works 66 used to train the CWAMLM 14. For example, the new creative work 52 can be a literary creative work, a musical creative work, a creative work of art, or the like. In another embodiment, the new creative work 52 can in a genre that differs from the genre of the existing creative works 66 used to train the CWAMLM 14.

The external interface 22 can be integrated with the CWAMLM 14 or the external interface 22 can be separate from the CWAMLM 14 but in two-way communication with the CWAMLM 14. The interface 22 can be configured to receive the inputs 62 in audible form via one or more microphones and/or via electronic text manually input by the user 50 for example via a keyboard. In addition, the interface 22 can be configured to output the feedback 64 in audible form via one or more speakers and/or in visual form by displaying electronic text on a display. The interface 22 can be a personal computer with a display and a keyboard, a laptop computer, a tablet computer, a mobile phone, and other devices. In an embodiment, the interface 22 may be the user device 34 (see FIG. 1).

The inputs 62 can include, but are not limited to, questions, comments, observations, and the like, relating to the new creative work 52 that the user 50 wishes to create or is creating. The feedback 64 provided by the CWAMLM 14 to the user 50 in response to the inputs 62 assist the user 50 to create the new creative work 52. The feedback 64 can include, but is not limited to, comments or observations in response to the input 62 provided by the user 50, suggestions to the user 50 for improving, enhancing or changing the new creative work 52, questions to the user 50, and other feedback suitable for aiding the user 50 in creating the new creative work 52.

The inputs 62 and the feedback 64 take too many forms to be able to list each one. The following are non-limiting examples of inputs 62 and feedback 64 to help in explaining the concepts described herein. Many other examples exist, and these examples are not intended to be limiting.

### Example 1

The following is an example sequence relating to improving the first sentence of Abraham Lincoln's Gettysburg Address. In this example, the CWAMLM 14 has been trained on a number of literary works as well as at least one literary work on how to write a literary work, for example Stephen King's On Writing: A Memoir Of The Craft.
Example User Input to the CWAMLM: How would you improve this sentence? “Four score and seven years ago our fathers brought forth on this continent, a new nation, conceived in Liberty, and dedicated to the proposition that all men are created equal.”
Example Feedback from the CWAMLM: I think you should change it to “Four score and seven years ago our fathers brought forth on this continent, a new nation, conceived in Liberty, and dedicated to the proposition that all men are created equal but not immediately entitled to vote.”
The feedback from the CWAMLM is based on the fact that the CWAMLM has been trained with the knowledge that when the constitution was first ratified, only land-owning white men who were at least twenty-one years old could vote.

### Example 2

The following is an example iterative sequence involving development of a website that would deploy the creative work creation systems and methods described herein.
User Input: I want to use a slogan on a website that says “Don't write alone”; can you improve this?
Feedback: “Don't write alone, find your muse.”
User Input: Perfect.
Feedback: “Don't write alone, find your muse.” I hope you incorporate this slogan.
User Input: I just did. The following is a section of text I would like you to rewrite: “This writing assistant, which we call Muse gives you the support every writer needs. The encouraging coach or fresh perspective for unlocking next steps Muse is there when time is short and need a little help reworking that single sentence. Even better if that smart friend is in your pocket, ready to help whenever you need it . . . your own personal muse.”
Feedback: “Muse gives you the support every writer needs. The encouraging coach or fresh perspective for unlocking next steps Muse is there when time is short and you need a little help reworking that single sentence. Even better if that smart friend is in your pocket, ready to help whenever you need it . . . your own personal muse.”

Referring to FIG. 5, a creative work creation method 70 is illustrated. The method 70 uses the system 60 depicted in FIG. 4. At step 72, the CWAMLM is created by training a machine learning algorithm using a plurality of existing creative works. The CWAMLM is now ready to assist the user in creating a new creative work. At step 74, the user provides one or more inputs into the CWAMLM concerning a new creative work that is being created by the user. Typically, the new creative work being created by the user will be from the same or similar genre as the existing creative works used to train the CWAMLM. However, in one embodiment, the new creative work could be from a different genre than the genre of the creative works used to train the CWAMLM. At step 76, the CWAMLM generates feedback concerning the new creative work, where the feedback is based on the input. At step 78, the feedback is output to the user.

In one embodiment, the input and the feedback could be a single iteration (in other words, a single input and a single feedback). For example, this single iteration can occur when the user wishes to have little assistance in creating the creative work and/or when the initial feedback is sufficient to satisfy the user. In another embodiment, the input and the feedback could be multiple iterations (in other words, multiple inputs and multiple feedback in response to each input) in which case the method 70 loops back 80 to step 74 and steps 74, 76, 78 are repeated.

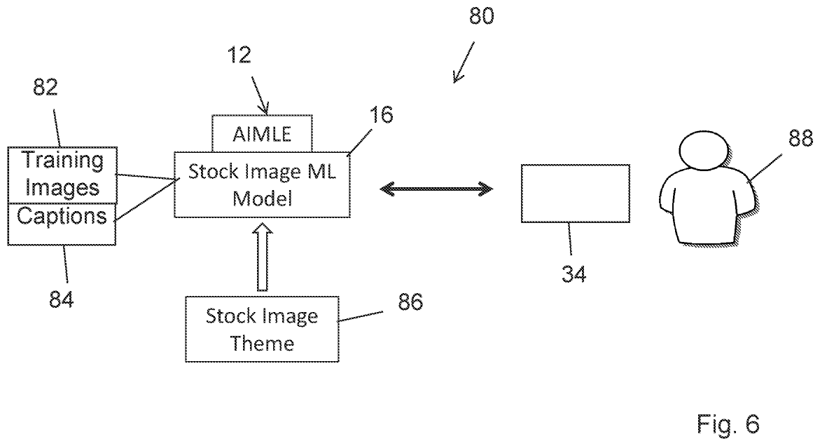

Referring now to FIG. 6, an example system 80 that includes the SIMLM 16 that can be used to generate stock images is illustrated. In FIG. 6, features that are the same or similar to features in FIGS. 1-3 are referenced using the same reference numerals. To create the SIMLM 16, a machine learning algorithm is trained using text/captions 84 and/or a plurality of images 82 associated with the captions/text 82. A caption is text, a heading, a title or brief explanation associated with an image that identifies or describes the image, conveys a message or information regarding the image, helps explain the image or what the image is trying to convey, and the like.

The training images 82 and the text/captions 84 may have a single common theme, or the training images 82 and the text/captions 84 can have a first theme, a second theme, a third theme, etc. For example, the training images 82 and the text/captions 84 can have an animal theme, or more specifically a dog theme, a cat theme, etc. The training images 82 and the text/captions 84 can have a science fiction theme, a monster theme, an automobile theme, and many other theme s too numerous to mention specifically. The themes of the training images 82 and the text/captions 84 used to train the SIMLM 16 may correspond to themes used by conventional stock image sources such as Shutterstock®, Getty Images®, and the like.

Once the SIMLM 16 is trained, the SIMLM 16 can be used to generate new stock images. For example, to create new stock images, a stock image theme 86 is input into the SIMLM 16. The SIMLM 16 then uses the input theme 86 as a “seed” to create one or more stock images based on the input theme 86. The stock image theme 86 can be an image, a caption or text, or a combination of an image and a caption/text. In one embodiment, the stock image theme 86 corresponds to a theme used for the training images 82 and the text/captions 84. In one embodiment, the machine learning algorithm used in the SIMLM 16 can incorporate a random number generator that, using the stock image theme 86 as input, generates a plurality of the stock images with the stock images being different from one another due to the random number generation involved in the SIMLM 16. The SIMLM 16 can generate a fixed, preprogrammed/predetermined number of stock images, or the number of stock images to be generated can be user selected.

The stock image theme 86 may be input by an entity that controls/owns/manages the SIMLM 16. The entity then can make the stock photos available to a user 88, for example via a website that is accessible by the user 88 using their device 34. In another embodiment, the user 88 can input the stock image theme 86 to generate the user's own stock images.

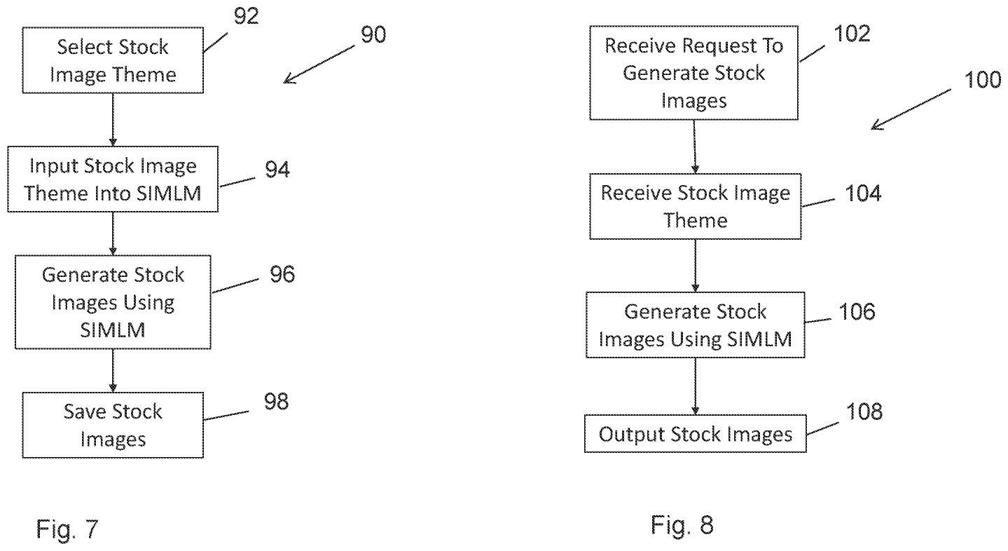

Referring to FIG. 7, one example of a method 90 of generating stock images using the system 80 of FIG. 6 is depicted. The method 90 may be referred to as an internal method or a back-office method performed by the entity that controls/owns/manages the SIMLM 16, with the resulting stock photos then made available to users, for example via a website. Assuming the SIMLM 16 has been trained, the method 90 includes selecting 92 the stock image theme and inputting 94 the stock image theme into the SIMLM. The SIMLM then generates 96 a plurality of stock images based on the input stock image theme, and the generated stock images are then stored 98 in suitable storage. The generated stock images can then be made available to users, for example via a website that allows users to select one or more of the stock images.

FIG. 8 illustrates another example of a method 100 of generating stock images using the system 80 of FIG. 6. In the method 100, a user may enter a request, for example on a website, to generate stock images. The request is received 102 along with the stock image theme 104 which is entered by the user. The stock image theme is then entered into the SIMLM which generates 106 the stock images based on the input stock image theme from the user. The stock images can then be output 108 to the user. The stock images may also be stored in suitable storage that is accessible by the user.

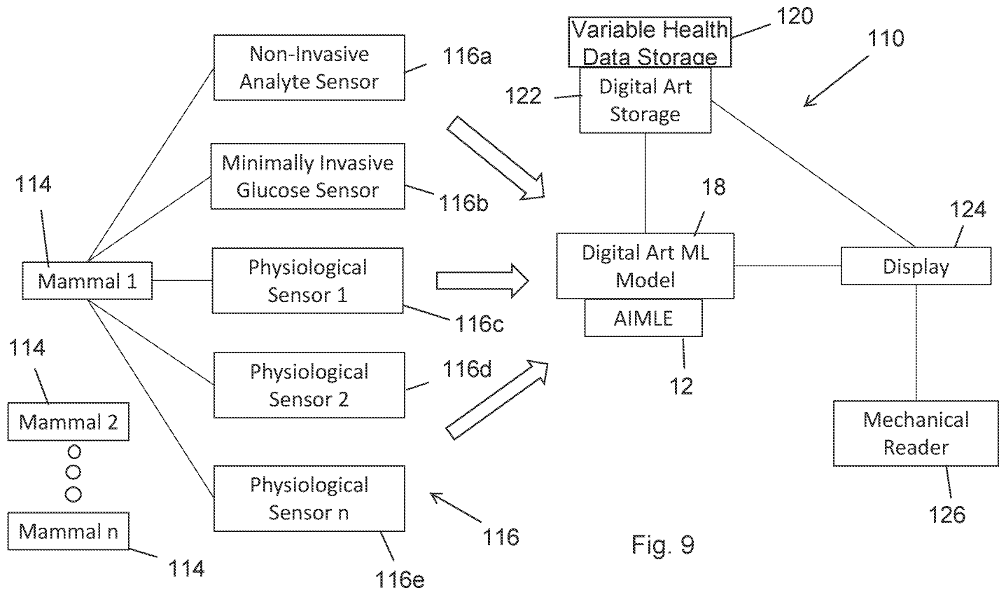

Referring now to FIG. 9, an example system 110 that includes the DAMLM 18 that can be used to generate digital art is illustrated. In FIG. 9, features that are the same or similar to features in FIGS. 1-3 are referenced using the same reference numerals. The DAMLM 18 can be created in a manner similar to the SIMLM by training a machine learning algorithm using a plurality of text and/or images. The DAMLM 18 can then be used to generate digital art based in variable health data that is input into the DAMLM 18.

As used herein, digital art refers to artwork that is created in electronic/digital form using software, computers, or other electronic devices. Digital art may also be referred to as computer art or a digital painting. Digital art as used herein does not include and specifically excludes mathematical plots, graphs, charts, histograms, pie charts and other conventional mathematical/scientific depictions of data.

As used herein, a mammal refers to a human or an animal such as a dog, cat, and the like. The animal may be domesticated or wild.

As used herein, variable health data refers to health-related data of a mammal that does or may vary over time and where a measurement at a particular moment in time can be performed to detect a value using a sensor. The variable health data can be one or more analytes in the mammal and/or one or more physiological parameters of the mammal.

Examples of analytes include, but are not limited to, naturally occurring substances, artificial substances, metabolites, and/or reaction products. Examples of analytes includes, but are not limited to, one or more of glucose (in blood or in interstitial fluid), alcohol, white blood cells, or luteinizing hormone. Additional examples of analytes include, but are not limited to, insulin, acarboxyprothrombin; acylcarnitine; adenine phosphoribosyl transferase; adenosine deaminase; albumin; alpha-fetoprotein; amino acid profiles (arginine (Krebs cycle), histidine/urocanic acid, homocysteine, phenylalanine/tyrosine, tryptophan); andrenostenedione; antipyrine; arabinitol enantiomers; arginase; benzoylecgonine (cocaine); biotinidase; biopterin; c-reactive protein; carnitine; pro-BNP; BNP; troponin; carnosinase; CD4; ceruloplasmin; chenodeoxycholic acid; chloroquine; cholesterol; cholinesterase; conjugated 1-β hydroxy-cholic acid; cortisol; creatine kinase; creatine kinase MM isoenzyme; cyclosporin A; d-penicillamine; de-ethylchloroquine; dehydroepiandrosterone sulfate; DNA (acetylator polymorphism, alcohol dehydrogenase, alpha 1-antitrypsin, cystic fibrosis, Duchenne/Becker muscular dystrophy, analyte-6-phosphate dehydrogenase, hemoglobin A, hemoglobin S, hemoglobin C, hemoglobin D, hemoglobin E, hemoglobin F, D-Punjab, beta-thalassemia, hepatitis B virus, HCMV, HIV-1, HTLV-1, Leber hereditary optic neuropathy, MCAD, RNA, PKU, Plasmodium vivax, sexual differentiation, 21-deoxycortisol); desbutylhalofantrine; dihydropteridine reductase; diptheria/tetanus antitoxin; erythrocyte arginase; erythrocyte protoporphyrin; esterase D; fatty acids/acylglycines; free β-human chorionic gonadotropin; free erythrocyte porphyrin; free thyroxine (FT4); free tri-iodothyronine (FT3); fumarylacetoacetase; galactose/gal-1-phosphate; galactose-1-phosphate uridyltransferase; gentamicin; analyte-6-phosphate dehydrogenase; glutathione; glutathione perioxidase; glycocholic acid; glycosylated hemoglobin; halofantrine; hemoglobin variants; hexosaminidase A; human erythrocyte carbonic anhydrase I; 17-alpha-hydroxyprogesterone; hypoxanthine phosphoribosyl transferase; immunoreactive trypsin; lactate; lead; lipoproteins ((a), B/A-1, β); lysozyme; mefloquine; netilmicin; phenobarbitone; phenytoin; phytanic/pristanic acid; progesterone; prolactin; prolidase; purine nucleoside phosphorylase; quinine; reverse tri-iodothyronine (rT3); selenium; serum pancreatic lipase; sissomicin; somatomedin C; specific antibodies (adenovirus, anti-nuclear antibody, anti-zeta antibody, arbovirus, Aujeszky's disease virus, dengue virus, Dracunculus medinensis, Echinococcus granulosus, Entamoeba histolytica, enterovirus, Giardia duodenalisa, Helicobacter pylori, hepatitis B virus, herpes virus, HIV-1, IgE (atopic disease), influenza virus, Leishmania donovani, leptospira, measles/mumps/rubella, Mycobacterium leprae, Mycoplasma pneumoniae, Myoglobin, Onchocerca volvulus, parainfluenza virus, Plasmodium falciparum, polio virus, Pseudomonas aeruginosa, respiratory syncytial virus, rickettsia (scrub typhus), Schistosoma mansoni, Toxoplasma gondii, Trepenoma pallidium, Trypanosoma cruzi/rangeli, vesicular stomatis virus, Wuchereria bancrofti, yellow fever virus); specific antigens (hepatitis B virus, HIV-1); succinylacetone; sulfadoxine; theophylline; thyrotropin (TSH); thyroxine (T4); thyroxine-binding globulin; trace elements; transferrin; UDP-galactose-4-epimerase; urea; uroporphyrinogen I synthase; vitamin A; and zinc protoporphyrin.

The analyte(s) can also include one or more chemicals introduced into the mammal. The analyte(s) can include a marker such as a contrast agent, a radioisotope, or other chemical agent. The analyte(s) can include a fluorocarbon-based synthetic blood. The analyte(s) can include a drug or pharmaceutical composition, with non-limiting examples including ethanol; cannabis (marijuana, tetrahydrocannabinol, hashish); inhalants (nitrous oxide, amyl nitrite, butyl nitrite, chlorohydrocarbons, hydrocarbons); cocaine (crack cocaine); stimulants (amphetamines, methamphetamines, Ritalin, Cylert, Preludin, Didrex, PreState, Voranil, Sandrex, Plegine); depressants (barbiturates, methaqualone, tranquilizers such as Valium, Librium, Miltown, Serax, Equanil, Tranxene); hallucinogens (phencyclidine, lysergic acid, mescaline, peyote, psilocybin); narcotics (heroin, codeine, morphine, opium, meperidine, Percocet, Percodan, Tussionex, Fentanyl, Darvon, Talwin, Lomotil); designer drugs (analogs of fentanyl, meperidine, amphetamines, methamphetamines, and phencyclidine, for example, Ecstasy); anabolic steroids; and nicotine. The analyte(s) can include other drugs or pharmaceutical compositions. The analyte(s) can include neurochemicals or other chemicals generated within the mammalian body, such as, for example, ascorbic acid, uric acid, dopamine, noradrenaline, 3-methoxytyramine (3MT), 3,4-Dihydroxyphenylacetic acid (DOPAC), Homovanillic acid (HVA), 5-Hydroxytryptamine (5HT), and 5-Hydroxyindoleacetic acid (FHIAA).

Examples of the physiological parameters can include, but are not limited to, blood pressure, heart rate, respiration rate, skin temperature, internal body temperature, blood oxygen level, carbon dioxide level, and an electrocardiogram.

Machine learning models that generate digital art from input data are known in the art. An AI machine learning engine that can be used to generate digital art from input data is the AI engine created by Know Labs, Inc. of Seattle, Washington. Additional examples of AI machine learning platforms that can generate digital art from input data include: https://art-ai.com/; https://creator.nightcafe.studio/create; https://www.starryai.com/create-nft-art-with-artificial-intelligence; and https://towardsdatascience.com/how-i-built-an-ai-text-to-art-generator-a0c0f6d6f59f. Generating digital art from input data is also described in U.S. Pat. No. 11,151,153 which is incorporated herein by reference in its entirety.

The DAMLM 18 receives input variable health data that is obtained from one or more mammals 114 using one or more sensors 116. Examples of the sensors 116 can include, but are not limited to, one or more non-invasive analyte sensors 116a, one or more minimally invasive analyte sensors 116b, and one or more physiological sensors 116c, 116d, 116e. In one embodiment, the sensors 116 can be non-invasive sensors that non-invasively obtain the variable health data. Non-invasive as used herein refers to a sensor that collects variable health data without introducing a mechanical/physical instrument into the mammal. A non-invasive sensor may directly physically contact the mammal, but no mechanical instrument thereof penetrates into the mammal. In another embodiment the sensors 116 can be non-invasive sensors together with one or more minimally invasive sensors. Minimally invasive as used herein refers to a sensor that collects variable health data using a portion thereof that extends partially into the mammal but the majority of the minimally invasive sensor remains outside the body.

Examples of the non-invasive analyte sensor 116a include, but are not limited, the non-invasive analyte sensors described in U.S. Pat. Nos. 10,548,503; 10,932,698; 11,033,208; 11,063,373; 11,058,331; and U.S. Patent Application Publication 2020/0187793; each of which is incorporated herein by reference in its entirety. The non-invasive analyte sensor 116a may sense one or more analytes in blood, interstitial fluid or other body fluid.

The minimally invasive analyte sensor 116b may be a glucose monitor, which may also be referred to as a transdermal glucose monitor, or a continuous glucose monitor, or a wearable glucose monitor. Examples of minimally invasive glucose monitors include the Freestyle Libre® sensor and the DexCom® series of glucose sensors.

The physiological sensors 116c, 116d, 116e may be sensors of known construction suitable for sensing physiological parameters such as, but not limited to, blood pressure, heart rate, respiration rate, skin temperature, internal body temperature, blood oxygen level, carbon dioxide level, and an electrocardiogram. Two or more physiological sensors can be incorporated together into a single device. For example, two or more physiological sensors, or a single one of the physiological sensors, can be incorporated into a smartwatch. Examples of smartwatches that include physiological sensors that can be used to non-invasively obtain physiological data include the Apple Watch®, the Galaxy Watch®, and the FitBit®. In an embodiment, the non-invasive analyte sensor and one or more of the physiological sensors may be combined together into a single device, for example a smart watch.

The variable health data obtained by the variable health data sensor(s) 116 is input into the DAMLM 18 which uses the input variable health data to create digital art. The variable health data can be stored in a suitable data storage 120 prior to being input into the DAMLM 18 or after being input into the DAMLM 18. The data storage 120 may include a database in which the variable health data is stored along with prior obtained variable health data from the same mammal or other mammals. The data storage 120 may be a single storage location, multiple storage locations, cloud storage, and other types of storage.

The digital art created by the DAMLM 18 is stored in a suitable data storage 122. In one embodiment, the data storage 122 may also include previously generated digital art stored therein. The data storage 122 in which the digital art is stored may be a single storage location, multiple storage locations, cloud storage, and other types of storage. In one embodiment, the data storage 120 and the data storage 122 may be combined with together, for example in a common server. The AIMLE 12 and the DAMLM 18 may also reside with the data storage 120 and/or the data storage 122, for example on the common server.

With continued reference to FIG. 9, the digital art created by the DAMLM 18 may be displayed on a display 124. In one embodiment, the display 124 may belong to a human mammal that provided some or all of the variable health data used to generate the digital art. The display 124 may be a monitor of a personal computer, a display screen of a tablet computer, a display screen of a laptop computer, a display screen of a mobile phone, or other type of display. The digital art created by the DAMLM 18 can be provided to the display 124 directly from the DAMLM 18, from the data storage 122, or from an intermediate device between the DAMLM 18 and the display 124.

In another embodiment, the digital art created by the DAMLM 18 can be printed onto a physical substrate, such as paper, canvas, glass, acrylic or other medium. The term “printed” as used herein is intended to encompass any technique for mechanically producing the digital art on a substrate including, but not limited to, digital printing such as inkjet printing, digital laser exposure, digital cylinder printing, and other printing techniques.

The generated digital art, whether displayed on the display 124 or printed onto a physical substrate, can be multicolor (i.e. red, green, blue (RGB)); monochromatic (i.e. a single color or shades of a single color); black and white; or grayscale.

The system 110 may also optionally include a mechanical reader 126, schematically shown in FIG. 9, that is used to read or interpret the digital art whether displayed on the display 124 or printed onto a physical substrate. The generated digital art may depict a clinical situation of the mammal(s) that provided the variable health data used to generate the digital art. For example, the clinical situation can be indicated by a particular shape(s) used in the digital image, by a particular color(s) or shade(s) of color(s) used in the digital image (for example, different colors could be assigned to different analytes such as one color assigned to glucose, one color assigned to ketones, one color assigned to c-reactive proteins, etc.), by locations of specific points in the digital image (the specific points may or may not form a geometric shape), by a code (such as a barcode or a QR code) embedded in the digital image, and many others. In an embodiment, more than one indicator indicating different clinical situations may be included in the digital image. The mechanical reader 126 detects the indicator(s) in the digital image, interprets the indicator(s) and displays the clinical situation to the user.

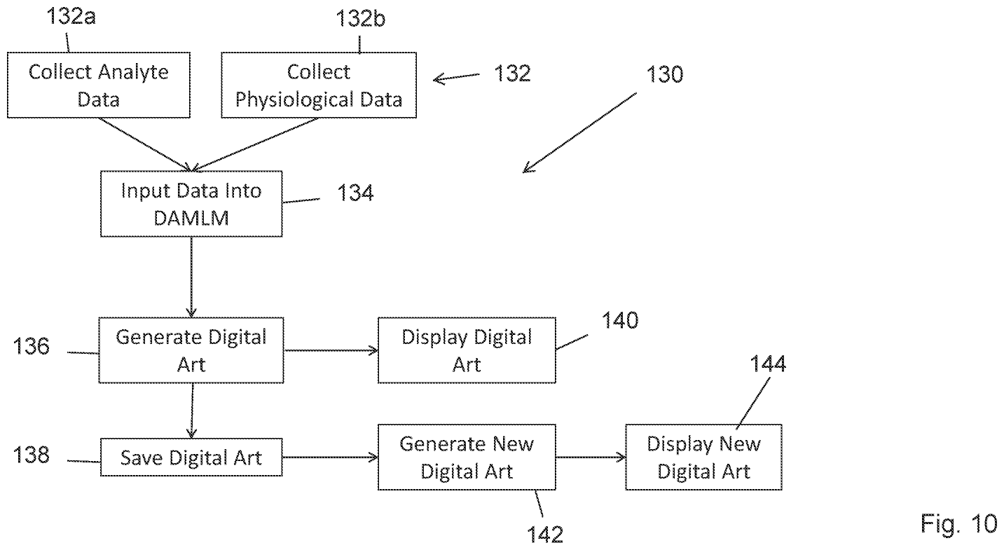

FIG. 10 schematically depicts a method 130 of generating digital art. The method 130 may be practiced using the system depicted in FIG. 9 or another system. The method 130 includes collecting 132 variable health data from one or more mammals such as one or more humans and/or one or more animals. The collecting step 132 can include collecting 132a analyte data and/or collecting 132b physiological data. The collecting of the variable health data can be performed non-invasively using one or more non-invasive analyte sensors and/or one or more non-invasive physiological sensors. The variable health data may be collected from a single human or from two or more humans. The analyte data may be analyte data for a single analyte or for a plurality of analytes, and the physiological data may be physiological data for a single physiological parameter or physiological data for a plurality of physiological parameters.

The obtained variable health data is input at 134 into the DAMLM that is trained to generate digital art. At 136, the digital art is generated by the DAMLM based partly or solely on the variable health data that has been input into the DAMLM. The digital art can then be saved at 138, for example in suitable data storage.

With continued reference to FIG. 10, in an embodiment, the digital art can be displayed at 140, for example on a display device. As explained above, the digital art can be displayed directly from the DAMLM or from the digital art stored in the data storage. The digital art may be displayed in real-time or in substantial real-time with the variable health data being collected (the delay between collection of the variable health data and display of the generated digital art is measured in milliseconds or microseconds), or displayed in near real-time or substantially near time (the delay between collection of the variable health data and display of the generated digital art is measured in seconds or minutes). The digital art may also be printed onto a physical substrate as described above.

With continued reference to FIG. 10, in an embodiment, the digital art that is generated can be saved in a database with prior generated digital art, and new digital art can be generated at 142 using the generated digital art and one or more of the prior generated digital art. That new digital art can then be displayed at 144.

In another embodiment, the variable health data collected at 132 that is input into the DAMLM can be stored in a database with prior collected variable health data (from the same mammal and/or different mammals), and the digital art can be generated by the DAMLM using the variable health data and the prior collected variable health data. In addition, in the case of variable health data collected from a single mammal, a time lapse of the digital art over time can be displayed to show changes in the digital art from that mammal over a time period.

In another embodiment, the generated digital art may be sent to a human mammal from whom the variable health data is collected and used to generate the digital art. The digital art may be displayed on a display device of the human mammal. The human mammal can also be permitted to select which variable health data is used to generate a digital image, and select various combinations of variable health data to be able to see how the digital image changes based on the variable health data that is selected.

In another embodiment, the variable health data from the mammal, for example a single human, can be collected while the mammal is in a first environment and the digital art can be generated from the variable health data from the first environment and displayed. Additional variable health data may also be collected from the mammal while the mammal is in a second environment, and the additional variable health data can be input into the DAMLM to generate additional digital art based on the additional variable health data from the second environment. For example, the first environment can be a workplace office, in a car travelling to and/or from work, while exercising, at a sporting event, or other high stress or high excitement environments. The second environment can be, for example, while relaxing at home, while sleeping, while on vacation, and other low stress environments. The two generated digital images can then be displayed, for example together or one after the other, to show changes in the digital images based on the two different environments.

In an embodiment, the digital art can be offered for sale on a cryptocurrency platform in which case the digital art can be referred to as NFT art. In another embodiment, the digital art can be printed onto a physical substrate and offered for sale like traditional works of art.

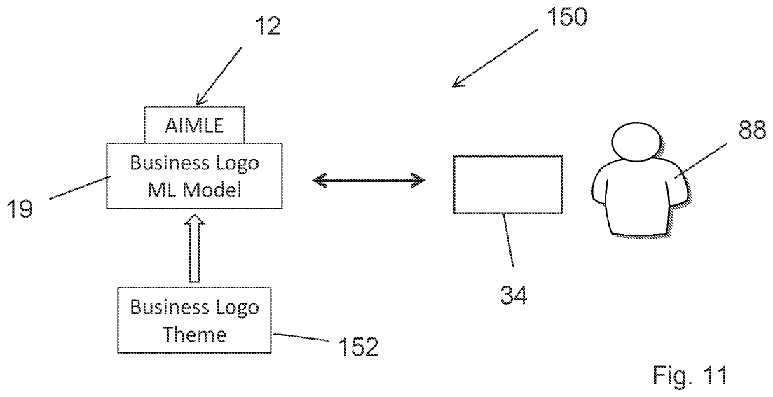

FIG. 11 depicts an example system 150 that includes the BLMLM 19 that can be used to generate one or more business logos is illustrated. In FIG. 11, features that are the same or similar to features in FIGS. 1-3 are referenced using the same reference numerals. A business logo is a drawing or image that a company, organization, group, or person conducting business uses to identify their business.

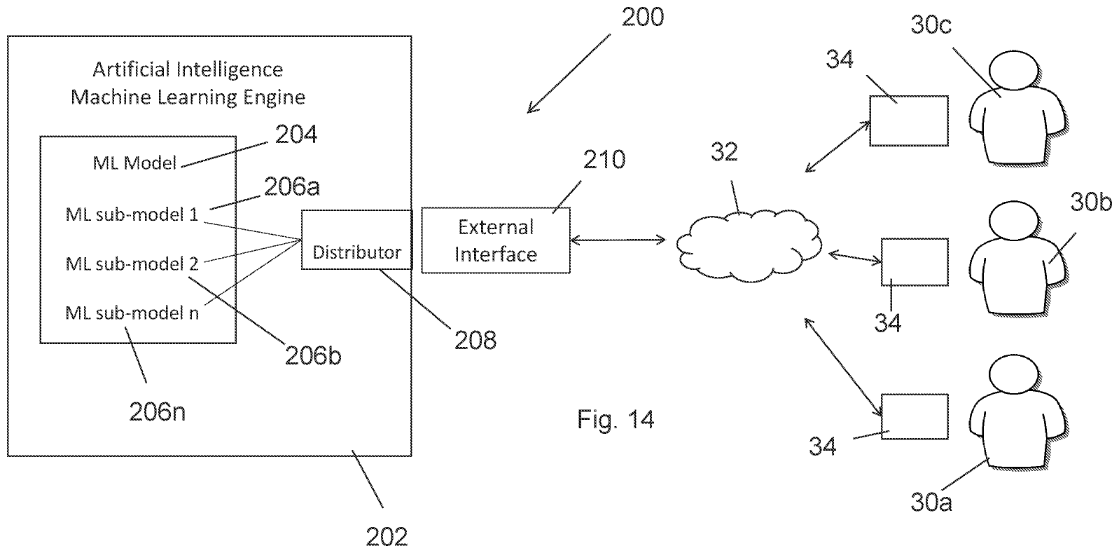

The BLMLM 19 can be created in a manner similar to the SIMLM by training a machine learning algorithm using text and/or images. The BLMLM 19 can then be used to generate one or more business logos based on an input request from a user 88. The text and/or images used to train the BLMLM 19 can be text and images that relate to business logos, including one or more books on designing or creating business logos. The text and/or images used to train the BLMLM 19 may relate to all types of businesses whereby the BLMLM 19 creates business logos for all types of businesses. Alternatively, the text and/or images used to train the BLMLM 19 may relate to a single type of business, for example home improvement stores, businesses selling athletic equipment, sports teams, and the like, whereby the BLMLM 19 creates business logos for the type of business it is trained on. Alternatively, as described below with respect to FIG. 14, the BLMLM 19 can have a plurality of trained sub-models, with each sub-model trained on a respective type of business.

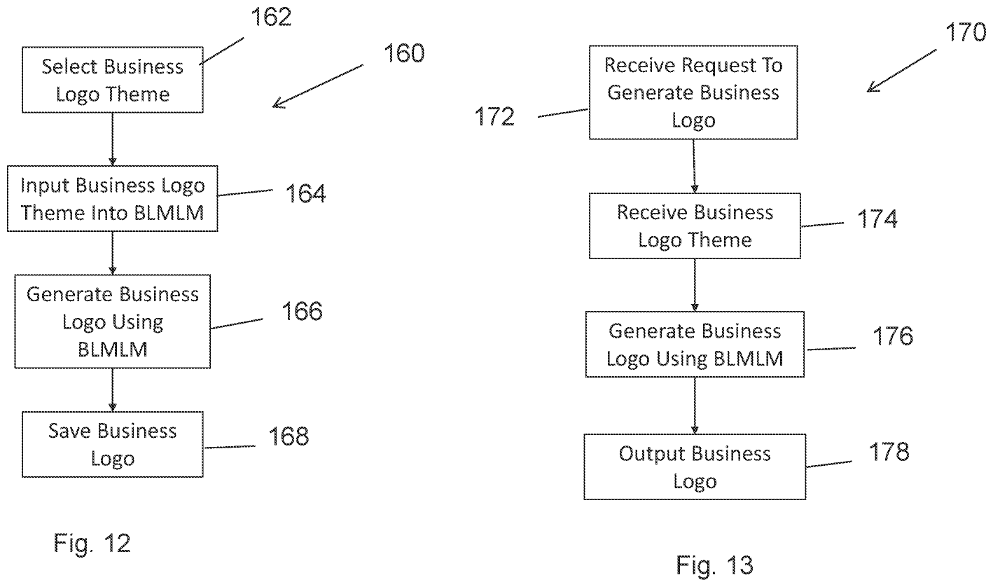

Referring to FIG. 12, one example of a method 160 of generating one or more business logos using the system 150 of FIG. 11 is depicted. The method 160 may be referred to as an internal method or a back-office method performed by the entity that controls/owns/manages the BLMLM 19, with the resulting business logo then made available to users, for example via a website. Assuming the BLMLM 19 has been trained, the method 160 includes selecting 162 the business logo theme 152 (FIG. 11) and inputting 164 the business logo theme 152 into the BLMLM. The BLMLM then generates 166 one or more business logos based on the input business logo theme, and the generated business logo(s) is then stored 168 in suitable storage. The generated business logo can then be made available to users, for example via a website that allows users to select the business logo(s).

FIG. 13 illustrates another example of a method 170 of generating a business logo using the system 150 of FIG. 11. In the method 170, a user may enter a request, for example on a website, to generate a business logo. The request is received 172 along with a theme 174 for the business logo which is entered by the user. The theme is then entered into the BLMLM which generates 176 at least one business logo based on the input theme from the user. The business logo can then be output 178 to the user. The business logo may also be stored in suitable storage that is accessible by the user.

Referring now to FIG. 14, another example of a system 200 that includes a multipurpose artificial intelligence machine learning engine (AIMLE) 202 with machine learning sub-models is depicted. In FIG. 14, features that are the same or similar to features in FIGS. 1-13 are referenced using the same reference numerals. The AIMLE 202 includes one or more trained machine learning models 204 (for example one or more of the CWAMLM 14, the SIMLM 16, the DAMLM 18, and the BLMLM 19 described above). One or all of trained machine learning models 204 can include a plurality of trained machine learning sub-models 206a, 206b . . . 206n. Each trained machine learning sub-model 206a-206n is trained with data belonging to a respective sub-genre of a larger data genre. A distributor 208 is in communication with the trained machine learning sub-models 206a-n. The distributor 208 is configured to receive an external input, for example via an external interface 210 (which may be similar to any one of the interfaces 22-28 described above), analyze the received external input, and distribute the received external input (or data based on the received external input) to at least one of the trained machine learning sub-models 206a-n to act on the received input and generate an output.

The distributor 208 may include artificial intelligence (in which case the distributor 208 may be referred to as an AI distributor) to allow the distributor 208 to analyze the received input, optionally generate a prompt based on the received input that is properly formatted for suitable action by the sub-model 206a-n, and direct the received input or the prompt based on the received input to the appropriate sub-model 206a-n.

The sub-models 206a-n are specialized trained machine learning models that relate to a common genre of data, with each sub-model 206a-n being trained on a sub-genre of data relating to the data genre. For example, the machine learning model 204 can be the CWAMLM 14 (FIG. 1), and the sub-models 206a-n can be trained on sub-genres of data relating to the data genre of the CWAMLM 14. The machine learning model 204 can be the SIMLM 16 (FIG. 1), and the sub-models 206a-n can be trained on sub-genres of data relating to the data genre of the SIMLM 16. The machine learning model 204 can be the DAMLM 18 (FIG. 1), and the sub-models 206a-n can be trained on sub-genres of data relating to the data genre of the DAMLM 18. The machine learning model 204 can be the BLMLM 19 (FIG. 1), and the sub-models 206a-n can be trained on sub-genres of data relating to the data genre of the BLMLM 19.

For example, assuming the model 204 is the CWAMLM 14, the CWAMLM 14 can relate to any genre of creative work. For example, assuming the genre is literature, the sub-models 206a-n can be trained on specific sub-genres of literature such as, but not limited to, science-fiction, horror, crime/mystery, etc. When a user is seeking assistance in generating a new literary work, and the user enters an input, the distributor 208 analyzes the input (and optionally generates a prompt based on the input) and directs the input (or the generated prompt) to the correct sub-model 206a-n for action on the input (or prompt) and generating an output in response to the input (or the prompt) which is provided to the user as described above. The SIMLM 16 and the DAMLM 18, and the sub-models thereof, can be constructed and operate similarly to the CWAMLM 14.

In another example, assuming the model 204 is the BLMLM 19, the sub-models 206a-n can be trained on specific sub-genres of business such as, but not limited to, home improvement stores, businesses selling athletic equipment, sports teams, and the like. When a user is seeking assistance in generating a new business logo, and the user enters a request for a new business logo, the distributor 208 analyzes the input (and optionally generates a prompt based on the input) and directs the input (or the generated prompt) to the correct sub-model 206a-n for action on the input (or prompt) and generating an output (such as a logo generated by the sub-model) in response to the input (or the prompt) which is provided to the user as described above.

Additional ideas encompassed herein include the following.

Idea 1: A method includes training a machine learning algorithm using a plurality of existing creative works to create a creative work assistant machine learning model, the existing creative works being in one genre; receiving a plurality of inputs from a user into the creative work assistant machine learning model concerning a new creative work that is being created by the user, the new creative work is in the one genre; for each one of the inputs, the creative work assistant machine learning model generating feedback concerning the new creative work; and outputting the feedback to the user.

Idea 2: A method includes training a machine learning algorithm using a plurality of existing creative works to create a creative work assistant machine learning model, the existing creative works being in one genre; a) receiving an input from a user into the creative work assistant machine learning model concerning a new creative work that is being created by the user, the new creative work is in the one genre; b) the creative work assistant machine learning model generating feedback concerning the new creative work based on the received input; c) outputting the feedback to the user; and d) repeating a)-c).

Idea 3: A creative work creation system includes an artificial intelligence machine learning engine that includes a creative work assistant machine learning model that is trained on a plurality of exiting creative works, the existing creative works being in one genre; an external interface that is in communication with the creative work assistant machine learning model, the external interface being configured to receive inputs from a user concerning a new creative work in the one genre that is being created by the user; and the creative work assistant machine learning model is configured to generate feedback concerning the new creative work for the received inputs and to output the feedback to the user via the external interface.

Idea 4: A method of generating digital art includes collecting variable health data non-invasively obtained from one or more mammals; inputting the variable health data into a digital art machine learning model that has been trained to generate digital art; generating new digital art using the digital art machine learning model based on the variable health data that has been input into the digital art machine learning model; and saving the generated new digital art.

Idea 5: A method includes training a machine learning algorithm using a plurality of images and captions associated with the images to create a stock image machine learning model; inputting a selected stock image theme into the stock image machine learning model; and creating a plurality of stock images using the stock image machine learning model based on the selected stock image theme.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A multipurpose artificial intelligence machine learning engine, comprising:
a first trained machine learning model that has been trained with a first set of data;
a first external interface associated with the first trained machine learning model by which a first user can interact with the first trained machine learning model;
a second trained machine learning model that has been trained with a second set of data; and
a second external interface associated with the second trained machine learning model by which a second user can interact with the second trained machine learning model.

2. The multipurpose artificial intelligence machine learning engine of claim 1, wherein the first trained machine learning model is trained to: assist the first user in creating a new creative work; or create digital art; or create stock images; or create a business logo.

3. The multipurpose artificial intelligence machine learning engine of claim 1, wherein the second trained machine learning model is trained to: assist the second user in creating a new creative work; or create digital art; or create stock images; or create a business logo.

4. The multipurpose artificial intelligence machine learning engine of claim 1, wherein the first trained machine learning model and the second trained machine learning model are generated from the same machine learning algorithm or generated from different machine learning algorithms.

5. The multipurpose artificial intelligence machine learning engine of claim 1, wherein the first set of data and the second set of data comprises images, text, sounds, and combinations thereof.

6. An artificial intelligence machine learning engine, comprising:
a first trained machine learning sub-model that is trained with data belonging to a first sub-genre of a data genre;
a second trained machine learning sub-model that is trained with data belonging to a second sub-genre of the data genre;
a distributor in communication with the first trained machine learning sub-model and the second trained machine learning sub-model, the distributor is configured to receive an external input, analyze the external input, and distribute the external input to the first trained machine learning sub-model or to the second trained machine learning sub-model.

7. The artificial intelligence machine learning engine of claim 6, wherein the data genre relates to: a creative work; digital art; stock images; or business logos.

8. The artificial intelligence machine learning engine of claim 6, wherein the data genre comprises literature.

9. A method comprising:
generating a first trained machine learning model that is trained with a first set of data;
generating a second trained machine learning model that is trained with a second set of data;
allowing a first user to access and interact with the first trained machine learning model via a first external interface associated with the first trained machine learning model; and
allowing a second user to access and interact with the second trained machine learning model via a second external interface associated with the second trained machine learning model.

10. The method of claim 9, further comprising storing the first trained machine learning model and the second trained machine learning model in at least one common storage location.

11. The method of claim 9, comprising generating the first trained machine learning model by training a machine learning algorithm using the first set of data, and generating the second trained machine learning model by training the machine learning algorithm using the second set of data; or
generating the first trained machine learning model by training a first machine learning algorithm using the first set of data, and generating the second trained machine learning model by training a second machine learning algorithm using the second set of data.

12. The method of claim 9, wherein the first trained machine learning model is trained to: assist the first user in creating a new creative work; or create digital art; or create stock images; or create a business logo.

13. The method of claim 9, wherein the second trained machine learning model is trained to: assist the second user in creating a new creative work; or create digital art; or create stock images; or create a business logo.

14. The method of claim 9, comprising generating the first trained machine learning model and the second trained machine learning model from the same machine learning algorithm.

15. The method of claim 9, wherein the first set of data and the second set of data comprises images, text, sounds, and combinations thereof.
